(19) United States
(12) Patent Application Publication
(10) Pub. No.: US 2007/0084014 A1
(43) Pub. Date: Apr. 19, 2007

(54) HINGE STRUCTURE AND FOLDABLE ELECTRONIC DEVICE USING THE SAME

(76) Inventor: Wen-Chieh Tseng, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/309,496

(22) Filed: Aug. 14, 2006

(30) Foreign Application Priority Data
Oct. 18, 2005 (TW) 94136283

(51) Int. Cl. E05D 11/10

(52) U.S. Cl. 16/330; 128/206.19; 361/683; 16/343

(57) ABSTRACT

A hinge structure for joining a first body, a second body and a third body includes a first hinge structure and a second hinge structure. The first hinge structure includes a pivot base joining the first body and a rotating part joining the third body. The rotating part pivots on the pivot base, so that the third body is able to swing open or close around a first rotating axis relative to the first body. The second hinge structure includes a sleeve disposed in the second body and a shaft disposed inside the sleeve. The shaft is able to rotate around a second rotating axis relative to the sleeve and joins the pivot base. As the shaft rotates, through the pivot base and the rotating part both joining the shaft, the third body and the first body are able to swing open or close relative to the second body.

### CROSS-REFERENCE TO RELATED APPLICATION

This application claims the priority benefit of Taiwan application serial no. 94136283, filed on Oct. 18, 2005. All disclosure of the Taiwan application is incorporated herein by reference.

### BACKGROUND OF THE INVENTION

1. Field of Invention

The present invention relates to a hinge structure and an electronic device, and particularly to a hinge structure having an expanded usable space of a foldable electronic device and a foldable electronic device using the same.

2. Description of the Related Art

In the modern information society, people increasingly rely on portable electronic products such as mobile phone, notebook computer and personal digital assistants (PDAs). These portable products have played so important roles, that people's daily lives are unimaginable without them. Along with continuous advances in electronic technology, the portable electronic products are experiencing non-stop updating towards ergonomic features and powerful functions never seen before.

In terms of a handset, many common styles thereof are available in the present market. Except for a straight handset where the operation interface (keypad) and the display screen locate on a same plane, there is also a foldable mobile phone where the operation interface (keypad) and the display screen can be folded together. Compared with the straight handset, the foldable mobile phone has overwhelming advantages, such as light and handy, larger display screen etc.

FIG. 1A and 1B are a front view and a side view of a conventional foldable mobile phone in open status, respectively. Referring to FIGS. 1A and 1B, a foldable mobile phone 100 includes a first body 110, a second body 120, a shaft 130, a keypad 140 and a liquid crystal display module (LCD module) 150. Wherein, the shaft 130 is disposed between the first body 110 and the second body 120 to make the second body 120 pivoting on the first body 110. Thus, the second body 120 is able to swing around a rotating axis R relative to the first body 110. Besides, the LCD module 1 50 is disposed in the second body 120, while the keypad 140 is disposed on the first body 110, so that a user can operate the handset assisted by the display of the LCD module 150.

In terms of the above-described foldable mobile phone 100, the shaft 130 only joins the first body 110 and the second body 120, and thus, the second body 120 swings around a single rotating axis R relative to the first body 110. Therefore, for the foldable mobile phone 100, the available spaces for use are at most four faces, i.e. the front and back faces of the first body 110 and the front and back faces of the second body 120.

However, for a foldable electronic device towards more powerful multi-functions today, regardless of a handset, a notebook computer or a personal digital assistant (PDA), such a limited useable space is a barrier for expanding the functions. Therefore, to improve the hinge structure design for expanding the useable space thereof is an urgent and difficult project in developing foldable electronic devices.

### SUMMARY OF THE INVENTION

An object of the present invention is to provide a foldable electronic device with a plurality of shafts with different rotating axes for expanding the usable space of the foldable electronic device.

Another object of the present invention is to provide a hinge structure featuring that a plurality of hinge structures with different rotating axes is disposed on a body of an electronic device to join the body with a plurality of other bodies for increasing the usable space of the electronic device.

Further an object of the present invention is to provide a hinge structure making a first body swing around a vertical rotating axis relative to a second body.

As embodied and broadly described herein, the present invention provides a foldable electronic device, which includes a first body, a second body, a third body, a first hinge structure and a second hinge structure. Wherein, the first body has a first side and a second side adjacent to the first side. The second body is disposed at the first side of the first body; the third body is disposed at the second side of the first body. The first hinge structure includes a pivot base and a rotating part. The pivot base joins the first body, while the rotating part joins the third body and pivots on the pivot base capable of rotating around a first rotating axis, so that the third body is able to swing open or close around the first rotating axis relative to the first body. The second hinge structure includes a sleeve and a shaft. The sleeve is disposed in the second body, while the shaft is disposed inside the sleeve and can rotate around a second rotating axis relative to the sleeve; one end of the shaft joins the pivot base and as the shaft rotates. The first body is driven and swing open or close around the second rotating axis relative to the second body through the pivot base joining the shaft and the rotating part pivoting on the pivot base.

In an embodiment of the present invention, the first rotating axis is perpendicular to the second rotating axis.

In an embodiment of the present invention, a through hole is disposed in the corresponding pivot base, while the rotating part includes a shaft disposed in the through hole to make the shaft rotate relative to the pivot base.

In an embodiment of the present invention, the pivot base includes a shaft, the rotating part has at least a through hole corresponding to the shaft and the shaft is disposed in the through hole, so that the shaft is able to rotate relative to the pivot base.

In an embodiment of the present invention, the foldable electronic device further includes a fourth body and a third hinge structure. The third hinge structure has a third rotating axis, the fourth body pivots on the third hinge structure and is able to swing open or close around the third rotating axis relative to the second body, while the third rotating axis is parallel to the first rotating axis.

As embodied and broadly described herein, the present invention further provides a hinge structure for joining a first body, a second body and a third body. The second body and the third body are disposed at a first side and a second side of the first body, respectively, wherein the first side is adjacent to the second side. The hinge structure includes a first hinge structure and a second hinge structure. Wherein, the first hinge structure includes a pivot base and a rotating part. The pivot base joins the first body, the rotating part joins the third body and pivots on the pivot base capable of rotating around a first rotating axis, so that the third body is able to swing open or close around the first rotating axis relative to the first body. The second hinge structure includes a sleeve and a shaft. The sleeve is disposed in the second body, while the shaft is disposed inside the sleeve and can rotate around a second rotating axis relative to the sleeve; one end of the shaft joins the pivot base and as the shaft rotates. The first body is driven and swing open or close around the second rotating axis relative to the second body through the pivot base joining the shaft and the rotating part pivoting on the pivot base.

In an embodiment of the present invention, the first rotating axis is perpendicular to the second rotating axis.

In an embodiment of the present invention, a through hole is disposed in the corresponding pivot base, while the rotating part includes a shaft disposed in the through hole to make the shaft rotate relative to the pivot base.

In an embodiment of the present invention, the pivot base includes a shaft, the rotating part has at least a through hole corresponding to the shaft and the shaft is disposed in the through hole, so that the shaft is able to rotate relative to the pivot base.

In an embodiment of the present invention, the hinge structure further includes a third hinge structure. The second body joins a fourth body through the third hinge structure. Wherein, the third hinge structure has a third rotating axis, the fourth body pivots on the third hinge structure and is able to swing open or close around the third rotating axis relative to the second body, while the third rotating axis is parallel to the first rotating axis.

In summary, the hinge structure and the foldable electronic device using the same of the present invention feature that a plurality of shafts with different rotating axes is disposed at different sides of a body to make the body join other bodies by mean of a special design of the shafts. On all the bodies, various input and output devices can be disposed according to real requirements, such as a screen, a keypad, a tablet and so on. In this way, the useable space of the electronic device is largely expanded.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIGS. 1A and 1B are a front view and a side view of a conventional foldable mobile phone in open status, respectively.

FIGS. 2A and 2B are a schematic front view and a schematic cubic drawing of a foldable electronic device provided by the first embodiment of the present invention, respectively.

FIG. 3 is a schematic local enlargement drawing showing a first hinge structure and a second hinge structure.

FIGS. 4A-4G are schematic drawings showing different statuses from closing to full opening of a foldable electronic device and all the bodies thereof provided by the present invention.

FIG. 5 is a schematic drawing of a foldable electronic device sample according to an embodiment of the present invention.

FIG. 6 is a schematic front view of a foldable electronic device provided by the second embodiment of the present invention.

FIG. 7 is a schematic front view of a foldable electronic device provided by the third embodiment of the present invention.

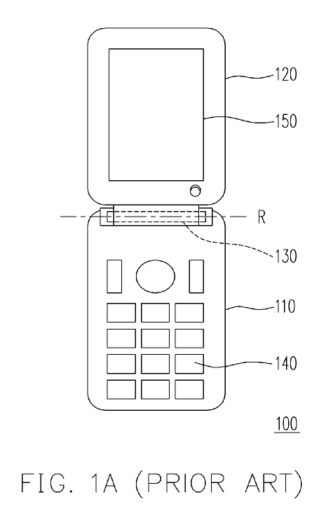

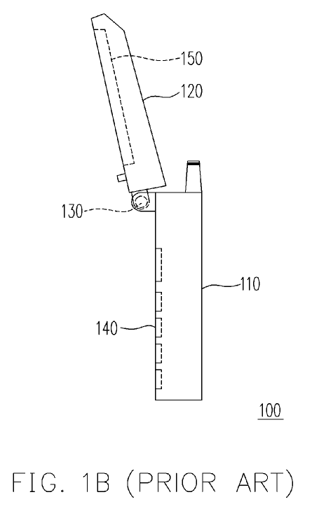

### DESCRIPTION OF THE EMBODIMENTS

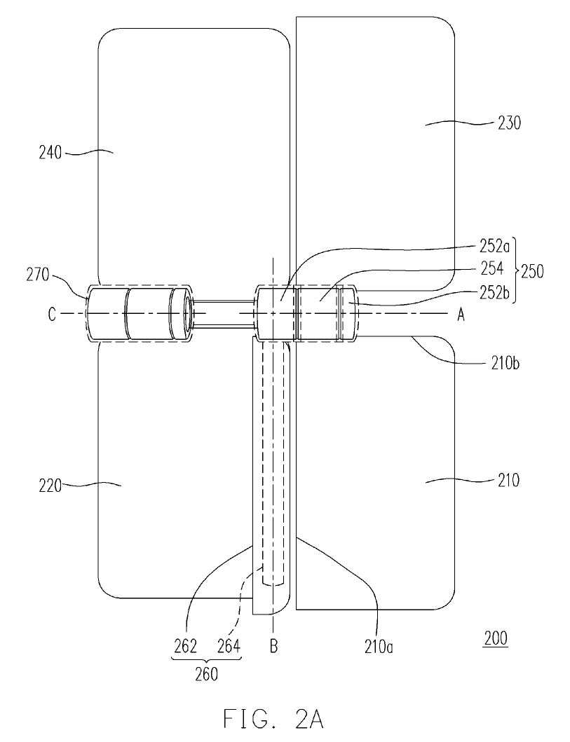

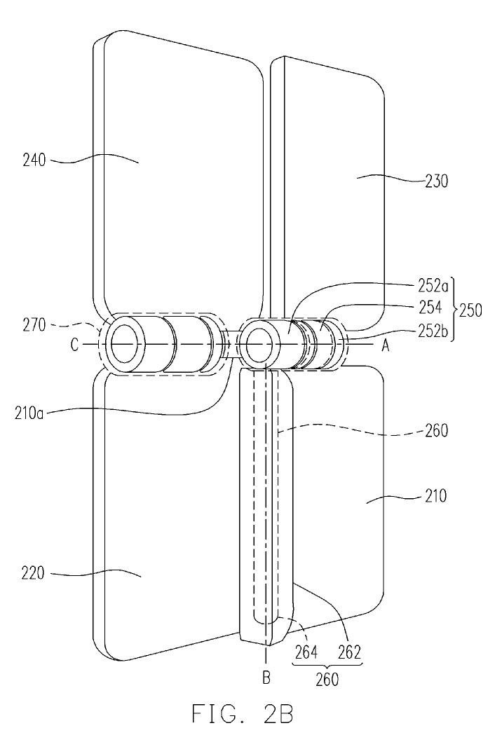

FIGS. 2A and 2B are a schematic front view and a schematic cubic drawing of a foldable electronic device provided by the first embodiment of the present invention, respectively. Referring to FIGS. 2A and 2B, the foldable electronic device 200 of the present invention mainly includes a first body 210, a second body 220, a third body 230, a fourth body 240, a first hinge structure 250, a second hinge structure 260 and a third hinge structure 270. The component structures and the relationships between them are described with the accompanying drawings hereinafter.

The first body 210 has a first side 210a and a second side 210b adjacent to the first side. In the embodiment, the first side 210a and the second side 210b are perpendicular to each other. The second body 220 is disposed at the first side 210a of the first body 210, the third body 230 is disposed at the second side 210b of the first body 210, and the fourth body 240 is disposed over the second body 230.

The first hinge structure 250 includes two pivot bases 252a and 252b and a rotating part 254. The pivot bases 252a and 252b join the first body 210; the rotating part 254 joins the third body 230 and pivots on the pivot bases 252a and 252b capable of rotating around a first rotating axis A, so that the third body 230 is able to swing open or close around the first rotating axis A relative to the first body 210.

The second hinge structure 260 includes a sleeve 262 and a shaft 264. The sleeve 262 is disposed at a side of the second body 220, wherein the side is adjacent to the first body 210. The shaft 264 is disposed inside the sleeve 262 and can rotate around a second rotating axis B relative to the sleeve 262. The first rotating axis A and the second rotating axis B are perpendicular to each other. It can be seen from the FIGS. 2A and 2B, the top end of the shaft 264 joins the pivot base 252a, and as the shaft 264 rotates, by means of the pivot base 252a joining the shaft 264 and the rotating part 254 pivoting on the pivot bases 252a and 252b, both the third body 230 and the first body 210 are driven and swing open or close around the second rotating axis B relative to the second body 220.

The fourth body 240 is disposed over the second body 220 and, by disposing the third hinge structure 270, swings open or close around a third rotating axis C relative to the second body 220. The third hinge structure 270 can have a same pivot structure as a general foldable electronic device to make the fourth body 240 swing open or close relative to the second body 220, therefore the description thereof is omitted for simplicity. In addition, the dispositions described herein that the third hinge structure 270 and the fourth body 240 locate over the second body 220 is an option only. In fact, the present invention does not limit the dispositions of the third hinge structure 270 and the fourth body 240.

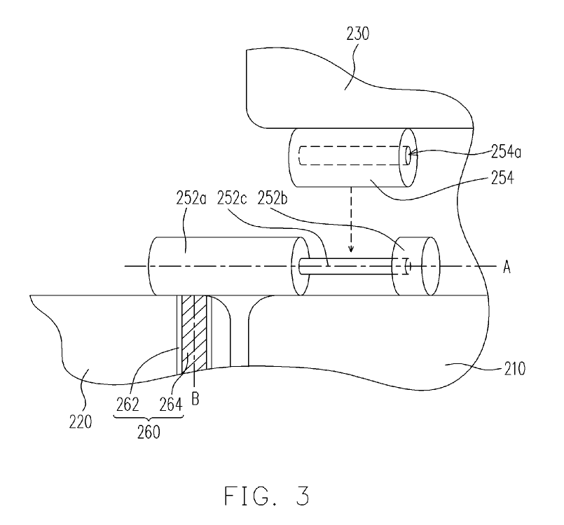

FIG. 3 is a schematic local enlargement drawing showing a first hinge structure and a second hinge structure. Referring to FIG. 3, one end of the pivot base 252a locates at a side of the second body 220, extends to a side of the first body 210 and is fixed on the first body 210; the pivot base 252b is disposed on the first body 210 but opposite to the pivot base 252a; a shaft 252c pivots between the pivot base 252a and the pivot base 252b. The rotating part 254 is disposed at a side of the third body 230 and corresponds to the location of the shaft 252c; a through hole 254a is disposed in the rotating part 254. As the first body 210 and the third body 230 are to be assembled together, the shaft 252c needs to be placed in the through hole 254a, so that the rotating part 254 rotates around the first rotating axis A relative to the pivot bases 252a and 252b.

As shown in FIG. 3, one end of the pivot base 252a joins the top end of the shaft 264. As the shaft 264 rotates around the second rotating axis B, the pivot base 252a, the rotating part 254 and the pivot base 252b are driven to rotate. Thus, the first body 210 and the third body 230 would swing open or close around the second rotating axis B relative to the second body 220.

Except for the above-described design of disposing a shaft 252c between two pivot bases 252a and 252b and disposing a corresponding through hole 254a inside the rotating a rotating part 254, there is another design of disposing a through hole between the two pivot bases 252a and 252b, disposing a corresponding shaft inside the rotating part 254 and putting the shaft in the through hole, so that the same object can be achieved that the third body 230 is able to swing open or close around the first rotating axis A relative to the first body 210. In fact, FIG. 3 only shows one of the embodiments of the first hinge structure 250 and the second hinge structure 260. Anyone skilled in the art can use other different pivoting designs to the first hinge structure 250 and the second hinge structure 260, and the present invention does not limit any feasible embodiment used in the first hinge structure 250 and the second hinge structure 260.

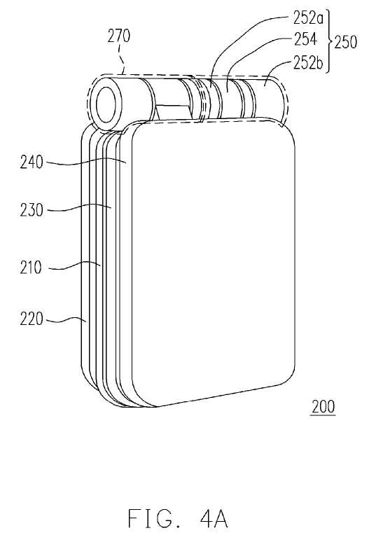

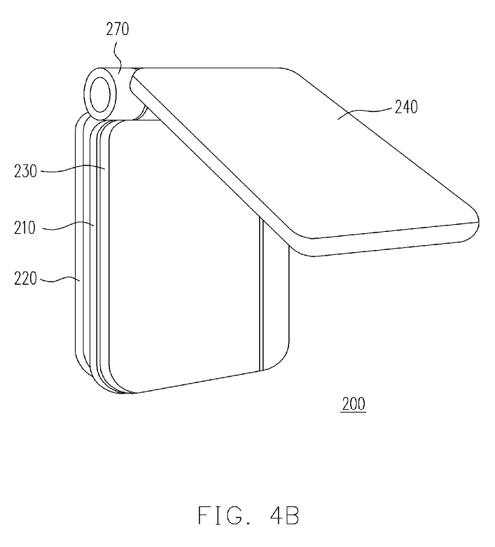

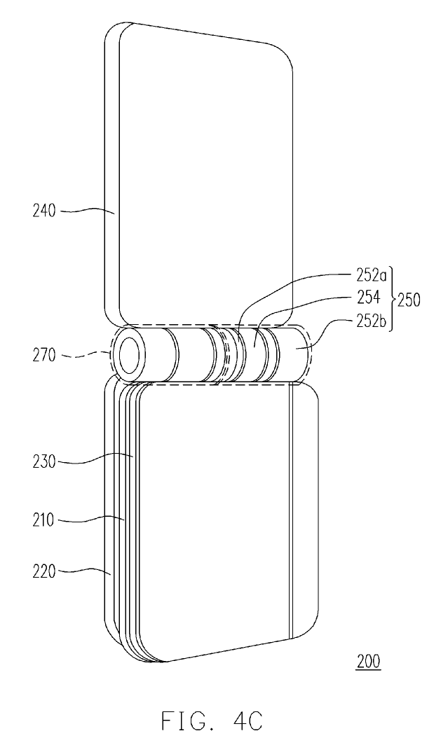

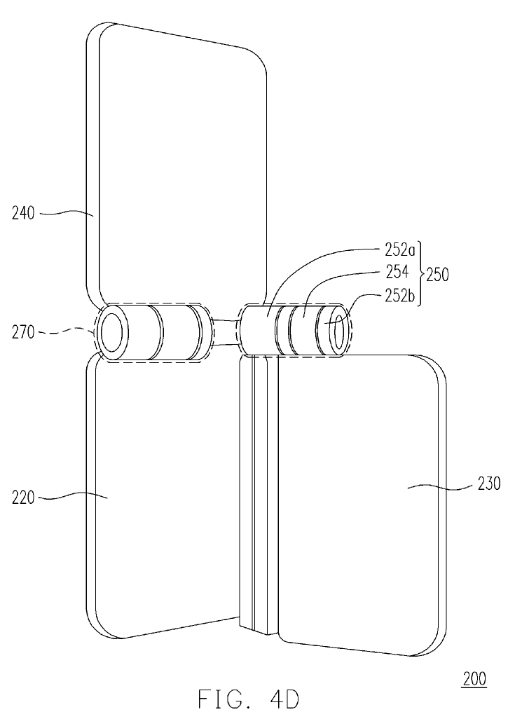

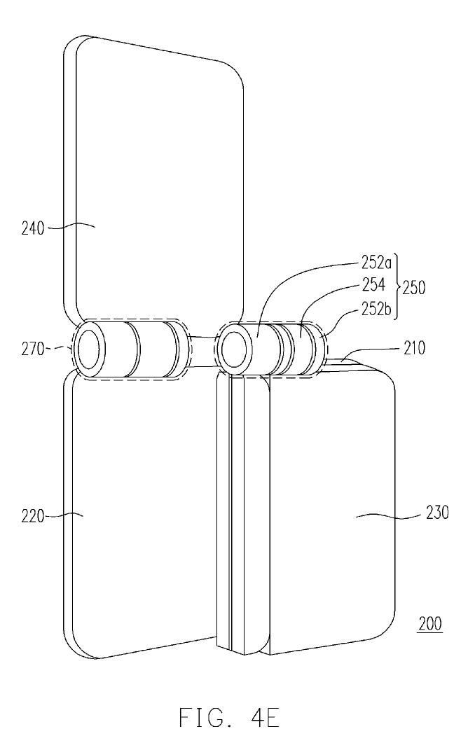

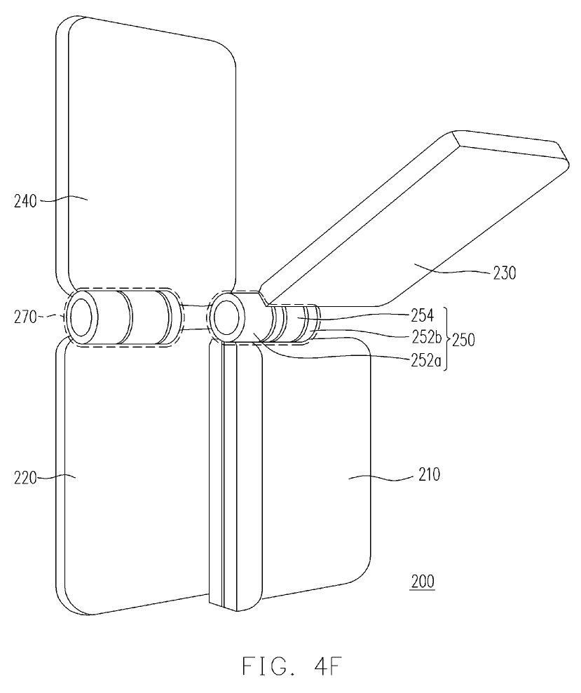

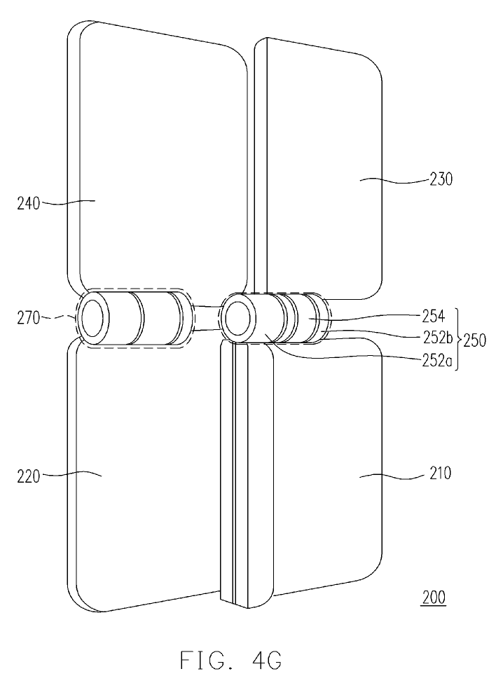

FIGS. 4A-4G are schematic drawings showing different statuses from closing to full opening of a foldable electronic device and all the bodies thereof provided by the present invention. First, referring to FIG. 4A, a first body 210, a second body 220, a third body 230 and a fourth body 240 are close and folded together herein. Next, referring to FIG. 4B, the third hinge structure 270 enables the fourth body 240 to swing up relative to the second body 220 until a top position as shown in FIG. 4C. Afterwards, referring to FIG. 4D, the first body 210 and the third body 230 swing right until an end position as shown in FIG. 4E. Finally, referring to FIG. 4F, the fourth body 240 swings up until an end position as shown in FIG. 4G.

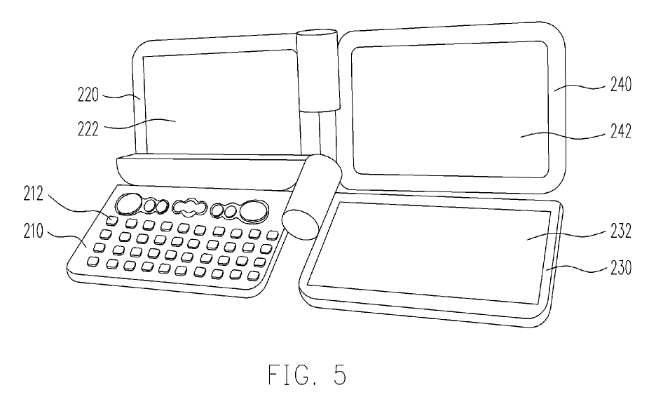

Depending on various requirements, a screen, a keypad, a tablet and so on can be disposed on all the bodies. FIG. 5 is a schematic drawing of a foldable electronic device sample according to an embodiment of the present invention. Referring to FIG. 5, in an present embodiment, two LCD screens 222 and 242 are disposed on the second body 220 and the fourth body 240, respectively, and a keypad 212 and a tablet 232 are disposed on the first body 210 and the third body 230, respectively. Using such an electronic device, when the first body 210, the second body 220, the third body 230 and the fourth body 240 are full open, a user can take advantage of all the functions of the double screens, the keypad and the tablet, which largely expands the functions of a foldable electronic device.

When a user does not use the electronic device, the user just simply folds all the bodies to get a compact volume; on the contrary, when a user wants to operate the electronic device, the user just unfolds all the bodies.

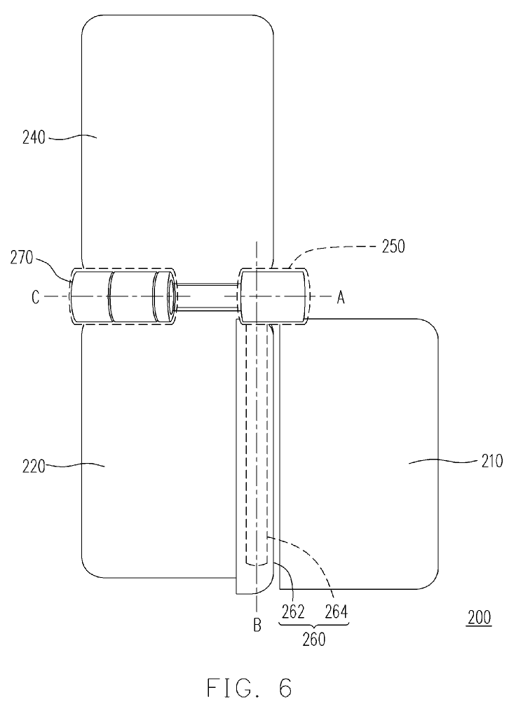

FIG. 6 is a schematic front view of a foldable electronic device provided by the second embodiment of the present invention. Referring to FIG. 6, it is the second embodiment and has a structure similar to the first embodiment, except the second embodiment has three foldable bodies for use only.

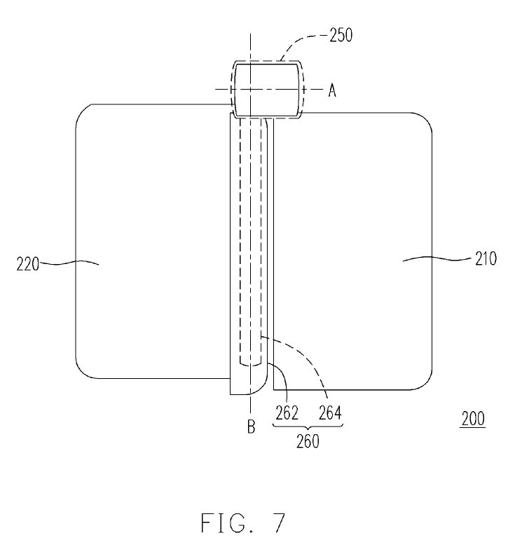

FIG. 7 is a schematic front view of a foldable electronic device provided by the third embodiment of the present invention. Referring to FIG. 7, it is the third embodiment and has a structure similar to the first embodiment, except the second embodiment has two foldable bodies and the second body 220 is able to swing left and right relative to the first body 210.

In summary, the hinge structure and the foldable electronic device using the same of the present invention feature that a plurality of shafts with different rotating axes is disposed at different sides of a body to make the body join other bodies by mean of a special design of the shafts. On all the bodies, various input and output devices can be disposed according to real requirements, such as a screen, a keypad, a tablet and so on. In this way, the useable space of the electronic device is largely expanded.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. A foldable electronic device, comprising:
a first body, having a first side and a second side adjacent to the first side;
a second body, disposed at the first side of the first body;
a third body, disposed at the second side of the first body;
a first hinge structure comprising a pivot base and a rotating part, wherein the pivot base joins the first body, the rotating part joins the third body and pivots on the pivot base and is able to rotate around a first rotating axis, so that the third body is able to swing open or close around the first rotating axis relative to the first body; and
a second hinge structure comprising a sleeve and a shaft, wherein the sleeve is disposed in the second body, the shaft is disposed inside the sleeve and able to rotate around a second rotating axis relative to the sleeve, and an end of the shaft joins the pivot base; as the shaft rotates, through the pivot base joining the shaft and the rotating part pivoting on the pivot base, the first body is driven and able to swing open or close around the second rotating axis relative to the second body.

2. The foldable electronic device as recited in claim 1, wherein the first rotating axis is perpendicular to the second rotating axis.

3. The foldable electronic device as recited in claim 1, wherein the pivot base has a corresponding through hole herein, the rotating part comprises a shaft able to rotate around the first rotating axis and the shaft is disposed inside the through hole, so that the shaft is able to rotate relative to the pivot base.

4. The foldable electronic device as recited in claim 1, wherein the pivot base comprises a shaft, the rotating part has at least a through hole corresponding to the shaft and the shaft is disposed inside the through hole, so that the shaft is able to rotate relative to the pivot base.

5. The foldable electronic device as recited in claim 1, further comprising a fourth body and a third hinge structure, wherein the third hinge structure is able to rotate around a third rotating axis, the fourth body pivots on the third hinge structure, so that the fourth body is able to swing open or close around the third rotating axis relative to the second body; the third rotating axis is parallel to the first rotating axis.

6. A hinge structure, used for joining a first body, a second body and a third body, wherein the second body and the third body are disposed at a first side and a second side of the first body, respectively, and the second side is adjacent to the first side; the hinge structure comprising:
a first hinge structure comprising a pivot base and a rotating part, wherein the pivot base joins the first body, the rotating part joins the third body and pivots on the pivot base and is able to rotate around a first rotating axis, so that the third body is able to swing open or close around the first rotating axis relative to the first body; and
a second hinge structure comprising a sleeve and a shaft, wherein the sleeve is disposed in the second body, the shaft is disposed inside the sleeve and able to rotate around a second rotating axis relative to the sleeve, and an end of the shaft joins the pivot base; as the shaft rotates, through the pivot base joining the shaft and the rotating part pivoting on the pivot base, the first body is driven and able to swing open or close around the second rotating axis relative to the second body.

7. The hinge structure as recited in claim 6, wherein the first rotating axis is perpendicular to the second rotating axis.

8. The hinge structure as recited in claim 6, wherein the pivot base has a corresponding through hole herein, the rotating part comprises a shaft able to rotate around the first rotating axis and the shaft is disposed inside the through hole, so that the shaft is able to rotate relative to the pivot base.

9. The hinge structure as recited in claim 6, wherein the pivot base comprises a shaft, the rotating part has at least a through hole corresponding to the shaft and the shaft is disposed inside the through hole, so that the shaft is able to rotate relative to the pivot base.

10. The hinge structure as recited in claim 6, further comprising a third hinge structure, wherein the second body joins a fourth body through the third hinge structure, the third hinge structure is able to rotate around a third rotating axis, the fourth body pivots on the third hinge structure, and the fourth body is able to swing open or close around the third rotating axis relative to the second body; the third rotating axis is parallel to the first rotating axis.
